(19) United States
(12) Patent Application Publication
(10) Pub. No.: US 2025/0178835 A1
(43) Pub. Date: Jun. 5, 2025

(54) CONTAINER HANDLING VEHICLE

(71) Applicant: AutoStore Technology AS, Nedre Vats (NO)

(72) Inventors: Trond Austrheim, Etne (NO); Ivar Fjeldheim, Haugesund (NO)

(21) Appl. No.: 18/844,548

(22) PCT Filed: Mar. 1, 2023
(86) PCT No.: PCT/EP2023/055178

§ 371 Date: Sep. 6, 2024

(30) Foreign Application Priority Data
Mar. 8, 2022 (NO) 20220288

(51) Int. Cl. B65G 1/06; B65G 1/04

(52) U.S. Cl. CPC B65G 1/065; B65G 1/0464; B65G 2201/0235

(57) ABSTRACT

The present invention provides a container handling vehicle (501) for moving on a rail system (108), the rail system comprising a first set of parallel rails (110) and a second set of parallel rails (111) arranged perpendicular to the first set of rails (110), the container handling vehicle comprising a first set of wheels and a second set of wheels and a mechanism for lifting the second set of wheels in a vertical direction.

### FIELD OF THE INVENTION

The present invention relates to a container handling vehicle for moving in two perpendicular directions upon a horizontal grid-based rail system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The upright members 102 may typically be made of metal, e.g. extruded aluminium profiles.

The framework structure 100 of the automated storage and retrieval system 1 comprises a horizontal grid-based rail system 108 (i.e. a rail grid) arranged across the top of framework structure 100. A plurality of container handling vehicles 201,301,401 may be operated on the rail system 108 to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a second direction X across the top of the frame structure 100, and a second set of parallel rails 111 arranged perpendicular to the first set of rails 110 to guide movement of the container handling vehicles 201,301,401 in a first direction Y which is perpendicular to the second direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers 106 out from and lowering of the containers 106 into the columns 105. The stacks 107 of containers 106 are typically self-supportive.

Each prior art container handling vehicle 201,301,401 comprises a vehicle body 201a, 301a,401a and first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 301b,201c,301c, 401b, 401c can be lifted and lowered, so that the first set of wheels 201b,301b,401b and/or the second set of wheels 201c,301c,401c can be engaged or disengaged with their respective set of rails 110, 111.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3 and guiding pins 4 adapted to engage a storage container 106. The lifting frame 2 can be lowered from the vehicle 201,301,401 so that the position of the lifting frame 2 with respect to the vehicle 201,301,401 can be adjusted in a third direction Z which is orthogonal the second direction X and the first direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z-6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, each rail may comprise two parallel tracks, or the rail system may comprise one track rails in one direction and two track rails in the other direction. Each rail may comprise a pair of track members, each track member being provided with a single track, the pair of track members being fastened together to provide a rail in a given direction.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the storage columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The prior art container handling vehicles 201,401 shown in FIGS. 2 and 4 have some advantageous properties in view of the cantilevered vehicle 301. The properties include guidance/support provided to a storage container accommodated in the cavity and the possibility of lifting heavily loaded storage containers without increasing the weight of the vehicle to counterbalance the weight of the storage container. Both properties entail that the vehicles may have increased acceleration/deceleration relative to the cantilevered vehicle 301. However, the potential increase in acceleration/deceleration is not fully realized due to instability caused by both vehicles 201,401 having substantially all drive and lifting components arranged above the cavity for accommodating a storage container.

### SUMMARY OF THE INVENTION

The present invention is defined by the attached claims and in the following:

In a first aspect, the present invention provides a container handling vehicle for moving on a rail system, the rail system comprising a first set of parallel rails and a second set of parallel rails arranged perpendicular to the first set of rails, the container handling vehicle comprising
a vehicle frame defining a first section and a second section of the container handling vehicle arranged side-by-side;
a first set of wheels comprising a first pair of wheels and a second pair of wheels, the first and second pairs of wheels arranged on opposite portions of the first section, allowing movement of the vehicle along a first direction on the rail system during use; and
a second set of wheels comprising a third pair of wheels and a fourth pair of wheels, the third and fourth pairs of wheels arranged on opposite sides of the vehicle, each of the sides extending from one edge of the first section to one edge of the second section, the second set of wheels allowing movement of the vehicle along a second direction on the rail system during use, the second direction being perpendicular to the first direction; the second set of wheels being arranged to be moveable in a vertical direction relative to the vehicle frame between an upper position in which the first set of wheels allows movement of the vehicle along the first direction, and a lower position in which the second set of wheels allows movement of the vehicle along the second direction,
wherein:
the third pair of wheels comprises a first wheel and a second wheel and the fourth pair of wheels comprises a third wheel and a fourth wheel;
each of the first wheel and the third wheel is mounted to a corresponding first wheel link, each first wheel link comprises a first pivot coupling and a second pivot coupling and is pivotably connected to the vehicle frame by the first pivot coupling;
each of the second wheel and the fourth wheel is mounted to a corresponding second wheel link, each second wheel link comprises a third pivot coupling and a fourth pivot coupling and is pivotably connected to the vehicle frame by the third pivot coupling;
the first wheel link supporting the first wheel and the second wheel link supporting the second wheel are connected via the respective second and fourth pivot couplings by a first coupler link; and
the first wheel link supporting the third wheel and the second wheel link supporting the fourth wheel are connected via the respective second and fourth pivot couplings by a second coupler link.

The rail system on which the container handling vehicle may move is a horizontal grid-based rail system and may also be termed a rail grid system.

In an embodiment of the container handling vehicle, the first wheel links may be arranged in the second section.

In an embodiment of the container handling vehicle, the second wheel links may be arranged in the first section.

In an embodiment of the container handling vehicle, the first and second coupler links may extend along opposite sides of the first section, i.e. may extend on opposite sides of the cavity provided by the first section, such that a storage container may be positioned between the first and second coupler links when accommodated in the cavity.

In an embodiment of the container handling vehicle, the second section may comprise an actuator assembly, the actuator assembly being arranged to move the first wheel links around the respective first pivot couplings between a first angular position and a second angular position, the movement of the first wheel links being transferred to the second wheel links via the first coupler link and the second coupler link, such that the second set of wheels is in the upper position or the lower position when the first wheel links are in the first angular position and the second angular position, respectively.

In an embodiment of the container handling vehicle, the second section may comprise a cross-member fixing the angular position of the first wheel links relative to each other, such that the first wheel links will move in unison around their respective first pivot coupling; and
the actuator assembly may be operatively connected to at least one of the first wheel links and arranged to move the first wheel link around its first pivot coupling between the first angular position and the second angular position.

The cross-member may be connected to both first wheel links, such that the positions of the first wheel links are fixed relative to each other.

The actuator assembly may be operatively connected between the vehicle framework and at least one of the first wheel links.

In an embodiment of the container handling vehicle, the actuator assembly may comprise a wheel lift motor or a linear actuator.

In an embodiment of the container handling vehicle, at least one of the first wheel links may comprise a fifth pivot coupling connected to the actuator assembly.

In an embodiment of the container handling vehicle, the actuator assembly comprises an actuator link pivotably connected to at least one of the first wheel links. The actuator link may be connected to the fifth pivot coupling of the at least one first wheel link.

The actuator link may be part of a movement transfer assembly configured to convert a rotational movement, or transfer a linear movement, of the actuator assembly to a substantially linear movement acting on the fifth pivot coupling of one of the first wheel links.

In an embodiment, the container handling vehicle may comprise a drive shaft interconnecting the first wheel links, the drive shaft operatively connected to drive the first wheel and the third wheel, preferably via respective drive bands.

The drive shaft may be connected to an electric motor. Rotational movement of the driveshaft may be transferred to the first wheel and the third wheel.

The drive shaft and the cross-member may be configured to move in parallel when the first wheel links are moved between the first and second angular positions.

The drive shaft may be configured to move in unison with the first wheel links between the first and second angular position. By moving in unison with the first wheel links and their respective supported wheels, both excessive wear of the drive bands due to stretching, and service involving tightening of the drive bands, are minimized.

In an embodiment, the container handling vehicle may comprise a wheel drive assembly for the first and third wheel, the wheel drive assembly may comprise the drive shaft, the cross member, a wheel drive motor for driving the drive shaft, and the first wheel links. All parts of the wheel drive assembly may move/pivot in unison relative to the vehicle frame. The wheel drive assembly may pivot around the first pivot couplings of the first wheel links.

The drive shaft may be arranged in the second section

In an embodiment, the container handling vehicle may comprise a first wheel drive motor for driving the drive shaft, the first wheel drive motor may be arranged in the second section.

The first wheel drive motor may be fixed to one of the first wheel links. The drive shaft may have a first end and a second end, the drive shaft may extend through a centerline of the first wheel drive motor, such that the first end is operably connected to the first wheel and the second end is operatively connected to the third wheel. The first end may be operatively connected to the first wheel by a first drive band, and the second end may be operatively connected to the third wheel by a second drive band.

In an embodiment, the container handling vehicle may comprise a second wheel drive motor for driving the second pair of wheels, the second wheel drive motor may be arranged in the second section, the second pair of wheels may preferably be operatively connected to the second wheel drive motor by a drive band.

In an embodiment of the container handling vehicle, the first coupler link and the second coupler link may be configured to move in the second direction towards the second wheel and the fourth wheel, respectively, when the first wheel links are moved from the second angular position to the first angular position. The first coupler link and the second coupler link may be configured such that the coupler links push the second wheel links to pivot around their respective first pivot couplings when the coupler links are moved in the second direction.

In an embodiment of the container handling vehicle, the first section may comprise a lifting device for lifting a storage container and may provide a cavity in which the storage container may be accommodated. The second wheel and the fourth wheel may be positioned on opposite sides of the cavity, such that a storage container may be positioned between the second and fourth wheels when accommodated in the cavity.

In an embodiment of the container handling vehicle, the lifting device may comprise at least one rotatable lifting shaft configured to raise and lower the lifting frame via a set of lifting bands, the lifting shaft arranged in the first section above the cavity.

In an embodiment, the container handling vehicle may comprise a lift drive motor for driving the lifting device, the lift drive motor may be arranged in the second section.

In an embodiment of the container handling vehicle, the first coupler link and the second coupler link are configured to move in the second direction towards the first wheel and the third wheel, respectively, when the first wheel links are moved from the first angular position to the second angular position.

In an embodiment of the container handling vehicle, the first coupler link and the second coupler link are plate-shaped.

Each of the plate-shaped coupler links may comprise a wheel recess for the wheel connected to the respective first wheel link. Each of the plate-shaped coupler links may feature a first end pivotably connected to the second pivot coupling of the respective second wheel link and is pivotably connected to the second pivot coupling of the respective first wheel link at a portion of the coupler link arranged above the wheel recess.

The plate-shaped coupler links may act as both force transferring elements between the wheel link arms and bodywork/covering closing off the lower portion of two sides of the container handling vehicle.

In an embodiment of the container handling vehicle, the first pivot coupling and the third pivot coupling may be arranged at a level below the second pivot coupling and the fourth pivot coupling.

In an embodiment, the container handling vehicle may comprise a rechargeable battery arranged in the second section.

In an embodiment, the container handling vehicle may comprise a set of electrodes for receiving power from a charging station, the electrodes may be arranged in the second section and connected to the rechargeable battery.

In an embodiment, the container handling vehicle may comprise a control unit arranged in the second section.

By having all drive motors, the battery and the control unit arranged in the second section, the cabling from the control unit to any of the controllable components is minimized. The construction of the container handling vehicle is thus simplified and made more cost-efficient.

In an embodiment of the container handling vehicle, the first pair of wheels, the second wheel and the fourth wheel are non-driven wheels. The non-driven wheels may also be termed non-motorized wheels.

In an embodiment, the container handling vehicle may comprise a set of adjustable or replaceable distance pins, the distance pins are configured to interact with switches or sensors on the lifting frame when the lifting frame is in an upper position.

The adjustable or replaceable distance pins ensure that the efficiency of the container handling vehicle may be optimized with respect to the height of the storage containers being lifted. The container handling vehicle may comprise four distance pins arranged to interact with four corner sections of the lifting frame. The distance pins may be configured to stabilize the lifting frame, and any storage container connected thereto, when the lifting frame is in an upper position.

In an embodiment of the container handling vehicle, each of the second wheel links may comprise a first edge section extending upwards from the level of the third pivot coupling and a second edge section extending downwards from the level of the third pivot coupling, the first edge section and the second edge section are directed away from the connected first wheel link and are inclined relative to each other and configured such that the second wheel link does not extend beyond an outer side of the first pair of wheels when moved around the third pivot coupling.

In an embodiment of the container handling vehicle, the first wheel and the third wheel are arranged in the second section.

In an embodiment of the container handling vehicle, the first section and the second section is arranged side-by-side such that a centre point of a footprint of the first section is arranged off centre relative a centre point of the footprint of the container handling vehicle.

In an embodiment of the container handling vehicle, the second wheel and the fourth wheel may have a smaller diameter than a diameter of the first wheel and the third wheel. The difference in wheel diameter allows the motorized wheels, i.e. the first wheel and the third wheel, to have a relatively large diameter providing optimum wheel contact with a rail system, while the non-driven wheels, i.e. the second wheel and the fourth wheel, may be positioned further away from the second section to allow more weight to be supported by the motorized wheels.

In a second aspect, the present invention provides a storage system comprising a container handling vehicle according to any of the preceding claims, comprising a framework structure having a plurality of storage columns for accommodating a vertical stack of storage containers and a rail system upon which the vehicle may move in two perpendicular directions above the storage columns.

In an embodiment, the storage system comprises a plurality of upright members and each storage column is defined by four of the upright members.

In an embodiment, the storage system comprises a rail system arranged on top of the upright members, the rail system comprising a first set of parallel rails and a second set of parallel rails arranged perpendicular to the first set of rails. The first and second set of rails providing a horizontal grid-based rail system defining a plurality of grid cells.

In an embodiment of the storage system, the footprint of the first section may be about the size of a grid cell of the rail system, and the second section may have a footprint less than the area of half a grid cell.

A grid cell may be defined as the cross-sectional area between the vertical centre planes of opposed rails running in the X direction and opposed rails running in the Y direction.

A grid cell opening may be defined as the open cross-sectional area between two opposed rails running in the X direction and two opposed rails running in the Y direction.

In an embodiment of the storage system, the footprint of the second section is less than half the size of the footprint of the first section (size ratio less than 1:2 relative the first section). When the container handling vehicle is positioned above a grid cell in a position where it can lift or lower a storage container into or out of the first section, the second section extends into a neighboring grid cell. However, the total footprint of the container handling vehicle is less than 1.5 grid cells in the second direction and maximum one grid cell wide in the first direction. In other words, the lateral extent of the container handling vehicle in the first direction corresponds to the lateral extent of the tracks in one cell, and maximum 1.5 grid cells in the second direction perpendicular to the first direction. Consequently, in an exemplary storage system, in which two of the container handling vehicles described above are operated and are oriented in opposite directions, they occupy three grid cells when passing each other in the first direction, whereas when passing each other in the second direction they can travel along neighboring rows of grid cells occupying two grid cells.

In a third aspect, the present invention provides a method of assembling a container handling vehicle according to any embodiment of the first aspect, the method comprising the steps of:
a) assembling the second section of the vehicle frame, the second section comprising the second pair of wheels, the first wheel links, the first wheel and the third wheel;
b) connecting the first section of the vehicle frame to the second section, the first section comprising the first pair of wheels, the second wheel links, the second wheel and the fourth wheel; and
c) interconnecting the first wheel links to the respective second wheel links by the first coupler link and the second coupler link.

In an embodiment of the method according to the third aspect, the second section assembled in step a. may comprise any or all of the first wheel drive motor, the second wheel drive motor, the lift drive motor, the actuator assembly, the drive shaft, the cross-member and the control unit.

In a fourth aspect, the present invention provides a method of changing the direction of travel of a container handling vehicle according to any embodiment of the first aspect, wherein the first wheel links are interconnected by a drive shaft and a cross-member, the drive shaft operatively connected to drive the first wheel and the third wheel, and the cross-member arranged to fix an angular position of the first wheel links relative to each other, such that the first wheel links will move in unison around their respective first pivot coupling;
the method comprising the step of:
   rotating the first wheel links, the drive shaft and the cross-member in unison around an axis extending between the first pivot couplings, such that the first wheel links are moved from a first angular position to a second angular position, and the second set of wheels are moved from an upper position, wherein the container handling vehicle may move in the first direction, to a lower position wherein the container handling vehicle may move in the second direction.

In an embodiment of the method according to the fourth aspect, the drive shaft is operatively connected to the first wheel by a first drive band and operatively connected to the third wheel by a second drive band, and the length of the drive bands are constant during the rotation of the the first wheel links, the drive shaft and the cross-member in unison around the axis extending between the first pivot couplings.

### BRIEF DESCRIPTION OF THE DRAWINGS

Embodiments of the invention are described in detail by way of example only and with reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of the container handling vehicle in FIG. 4 without side panels.

FIGS. 6 and 7 are exploded views of a first exemplary embodiment of a container handling vehicle according to the invention.

FIG. 8 is a perspective view of a wheel lifting assembly according to the invention.

FIGS. 9 and 10 are perspective side views of the container handling vehicle in FIGS. 6 and 7.

FIGS. 11-16 are perspective views of a second exemplary embodiment of a container handling vehicle according to the invention.

### DETAILED DESCRIPTION OF THE INVENTION

In the following, embodiments of the invention will be discussed in more detail by way of example only and with reference to the appended drawings.

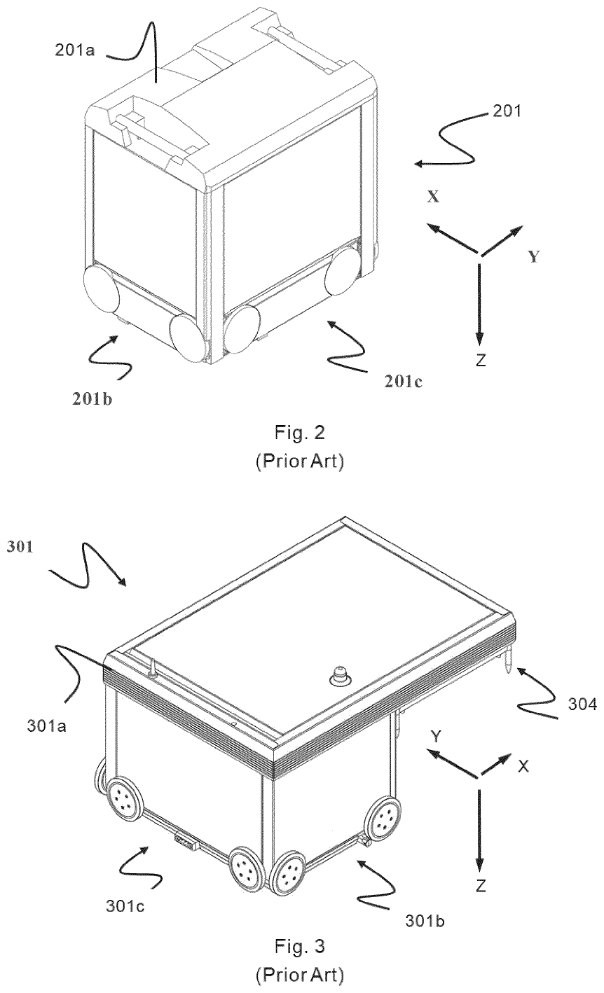

As discussed in the background section, the prior art container handling vehicles comprising a cavity for accommodating a storage container, see FIGS. 2, 4 and 5, have certain advantageous features. In particular, the guidance/support provided to a storage container when accommodated in the cavity entails that the vehicles may have increased acceleration/retardation relative to the cantilevered container handling vehicle 301 shown in FIG. 3. However, the potential increase in acceleration/retardation is not fully realized due to instability of the vehicles. The instability is caused by both vehicles 201,401 having most of the drive, power, control and lifting components arranged above the cavity, providing a high centre of gravity.

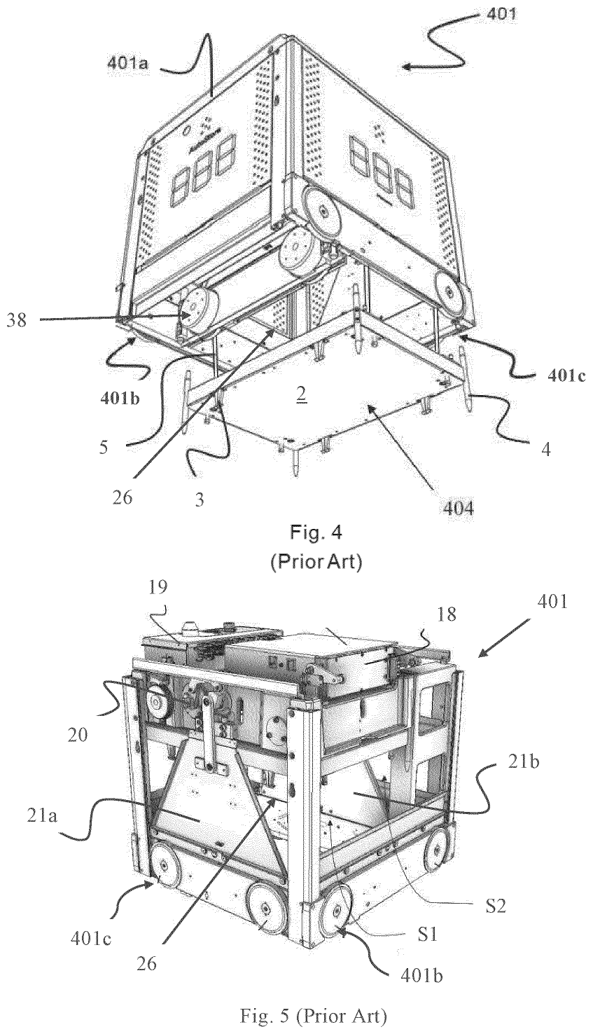

The vehicle body of the container handling vehicle in FIGS. 4 and 5 comprises a first section S1 and a second section S2 arranged side by side. The configuration of having a first section S1 and a second section S2 is disclosed in PCT/EP2018/077732. Due to the increased footprint relative to the footprint of the vehicle in FIG. 2, the stability is slightly improved. However, as shown in FIG. 5, the prior art container handling vehicle 401 features at least a control unit 19, a replaceable battery 18 and wheel lifting components, including a wheel lift shaft 20, arranged above the cavity 26. The wheel lift shaft 20 extends above the cavity interconnecting two opposite wheel lift plates 21a,21b. It is noted that the wheel drive motors of the container handling vehicle 401 are not arranged above the cavity. The positioning of the wheel motors is made possible by use of wheel hub motors 38. An advantage of using wheel hub motors is that all wheels of the container handling vehicle may be drive wheels providing increased traction of the wheels. Disadvantages of using multiple wheel hub motors is the relatively high cost and potentially increased service/maintenance. In addition, the power and torque that may be provided by the wheel hub motors are restricted since they must have a size allowing them to fit within the vehicle without extending into the cavity of the first section or obstructing each other in the second section.

The present invention provides a container handling vehicle having improved stability and traction of the drive wheels. Further advantages of the container handling vehicle described below includes lower service costs and the potential for improved manufacturing of the vehicle.

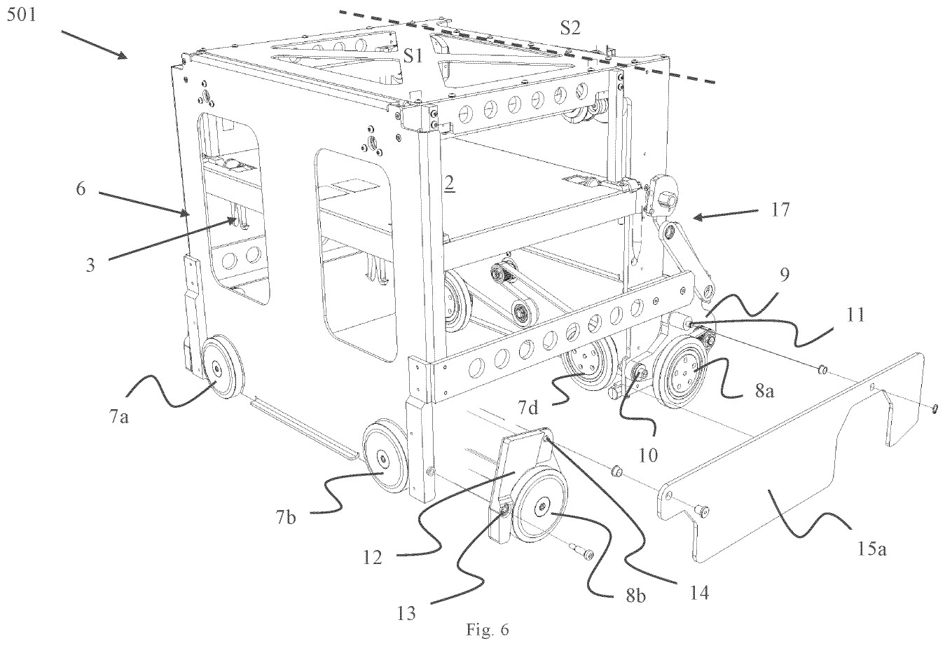

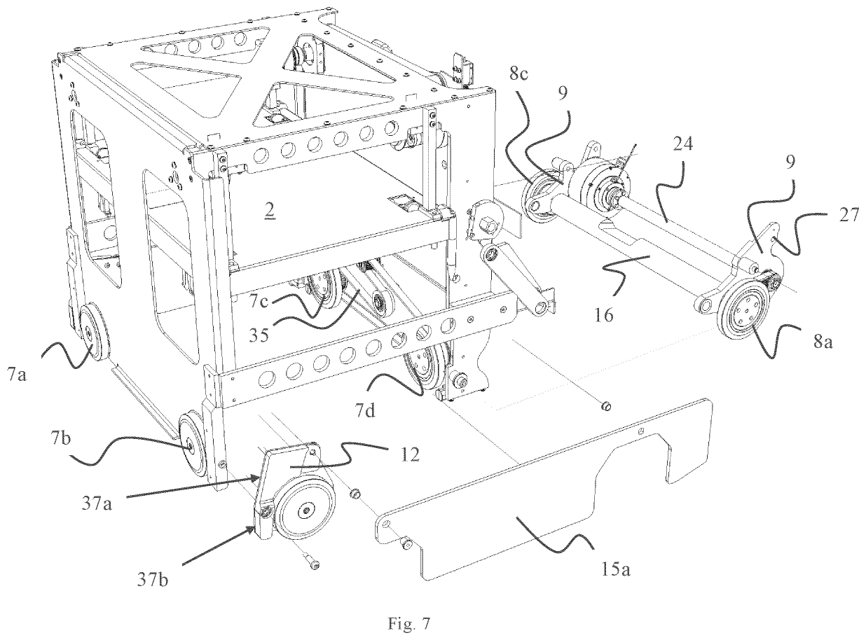

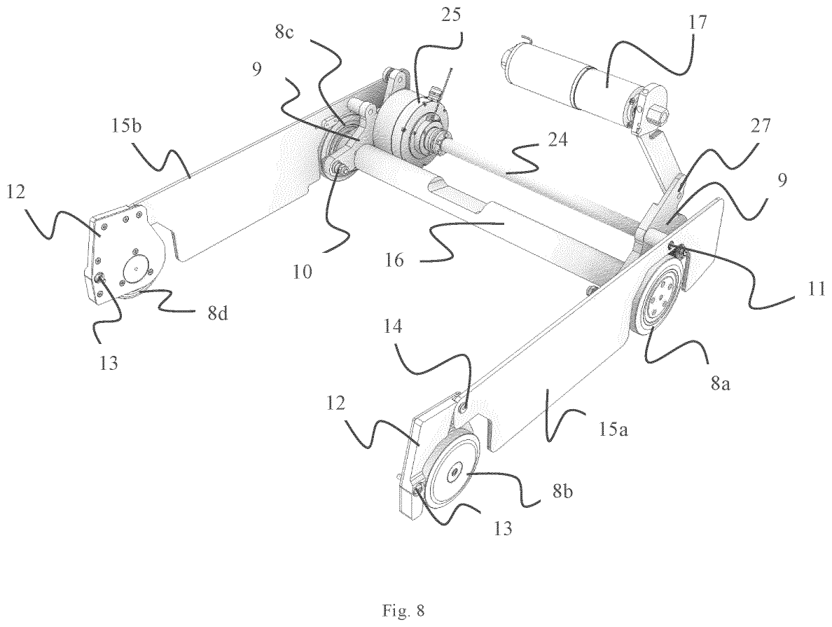

A first exemplary embodiment of a container handling vehicle 501 according to the invention is shown in FIGS. 6-10.

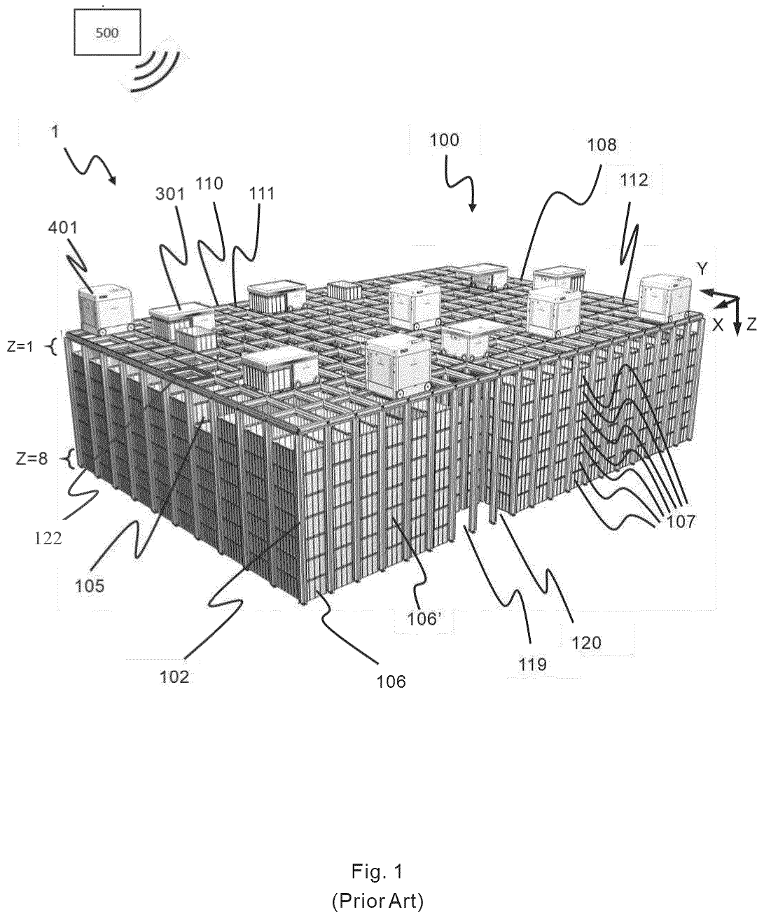

The container handling vehicle is suitable for use in prior art storage systems as discussed in the background section and shown in FIG. 1.

The container handling vehicle 501 features a vehicle frame 6 defining a first section S1 and a second section S2 of the container handling vehicle 501 arranged side-by-side, similar to the vehicle frame of the prior art vehicles 401 discussed above.

The first section S1 comprises a lifting device for lifting a storage container 106, and provides a cavity 26 in which the storage container 106 may be accommodated. The lifting device has a lifting frame 2 and two rotatable lifting shafts 33 configured to raise and lower the lifting frame 2 via a set of lifting bands 5. A lift drive motor 28 for driving the lifting device, i.e. rotating the lifting shafts, is arranged in the second section S2.

The container handling vehicle has a first set of wheels and a second set of wheels configured to move the vehicle upon on a rail system 108. The rail system comprises a first set of parallel rails 110 and a second set of parallel rails 111 arranged perpendicular to the first set of rails 110. The rail system is arranged in a horizontal, grid-based manner.

The first set of wheels comprises a first pair of wheels 7a, 7b and a second pair of wheels 7c, 7d. The first and second pairs of wheels are arranged on opposite portions of the first section S1, allowing movement of the vehicle 501 along a first direction Y on the rail system 108.

The second set of wheels comprises a third pair of wheels 8a, 8b and a fourth pair of wheels 8c, 8d. The third and fourth pairs of wheels are arranged on opposite sides of the vehicle, each of the sides extending from one edge of the first section S1 to one edge of the second section S2, the second set of wheels allowing movement of the vehicle 501 along a second direction X on the rail system 108. The second direction X is perpendicular to the first direction Y. The third pair of wheels comprises a first wheel 8a and a second wheel 8b, and the fourth pair of wheels comprises a third wheel 8c and a fourth wheel 8d. The second wheel 8b and the fourth wheel 8d are arranged in the first section S1 and are positioned on opposite sides of the cavity 26.

To allow a change of direction in which the vehicle travels upon the rail system, the second set of wheels is arranged to be moveable in a vertical direction Z relative to the vehicle frame 6. The second set of wheels may move between an upper position, in which the first set of wheels allows movement of the vehicle 501 along the first direction Y, and a lower position, in which the second set of wheels allows movement of the vehicle 501 along the second direction X.

The vertical movement of the second set of wheels is obtained by a wheel lift mechanism featuring pivotable wheel links 9,12 connected by coupler links 15a, 15b and driven by an actuator assembly 17,23.

In the wheel lift mechanism, each of the first wheel 8a and the third wheel 8c is mounted to a corresponding first wheel link 9 comprising a first pivot coupling 10 and a second pivot coupling 11. The first wheel links 9 are pivotably connected to the vehicle frame 6 by the respective first pivot coupling 10.

Similarly, each of the second wheel 8b and the fourth wheel 8d is mounted to a corresponding second wheel link 12 comprising a third pivot coupling 13 and a fourth pivot coupling 14. The second wheel links 12 are pivotably connected to the vehicle frame 6 by the respective third pivot coupling 13.

The first wheel link 9 supporting the first wheel 8a and the second wheel link 12 supporting the second wheel 8b are connected via the respective second and fourth pivot couplings 11,14 by a first coupler link 15a. The first wheel link 9 supporting the third wheel 8c and the second wheel link 12 supporting the fourth wheel 8d are connected via the respective second and fourth pivot couplings 11,14 by a second coupler link 15b. The first coupler link 15a and the second coupler link 15b extend along opposite sides of the cavity 26 in the first section S1.

The first coupler link 15a and the second coupler link 15b are plate-shaped and function as both force or movement transferring elements between the first wheel links 9 and the second wheel links 12, and as bodywork closing off two lower sides of the vehicle. The dual function of the coupler links 15a, 15b provides a cost efficient, lightweight and simple mechanical solution.

The second section S2 comprises a cross-member 16 connected to both first wheel links 9. The cross-member is configured to fix the angular position of the first wheel links 9 relative to each other, such that the first wheel links 9 will move in unison around their respective first pivot coupling 10.

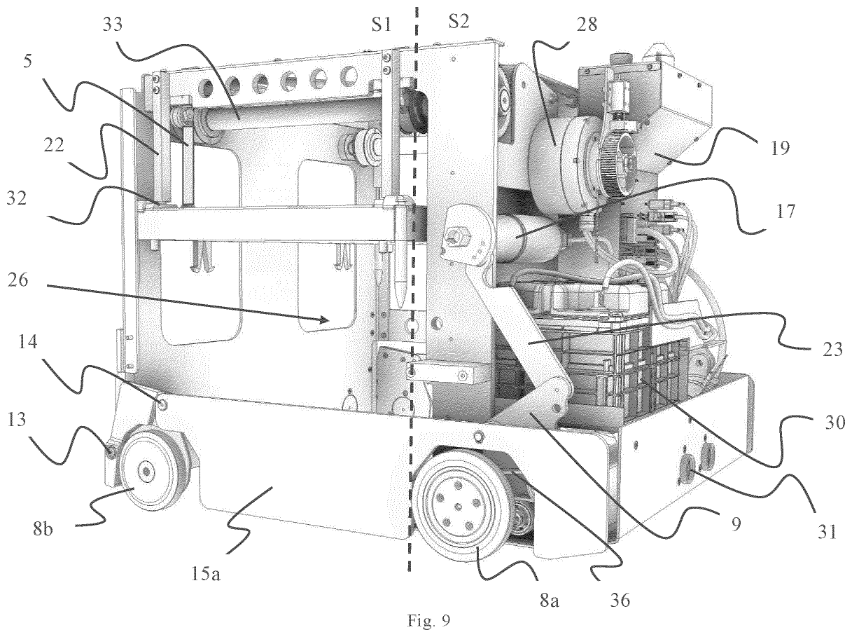

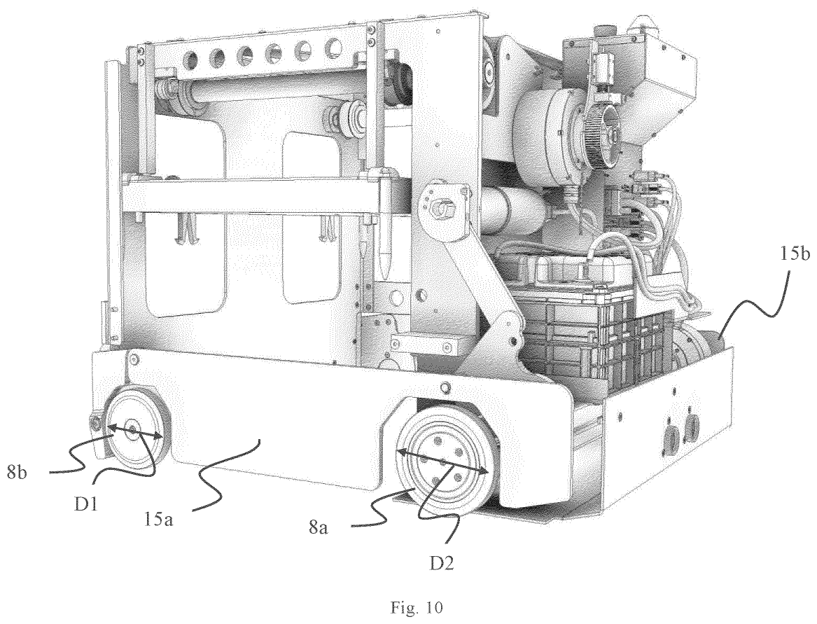

The actuator assembly is arranged in the second section S2 and features a wheel lift motor 17 and an actuator link 23. The actuator link is connected to one of the first wheel links 9 by a fifth pivot coupling 27. The actuator assembly is configured to move the first wheel links 9 around the respective first pivot couplings 10 between a first angular position and a second angular position. The movement of the first wheel links 9 is transferred to the second wheel links 12 via the first coupler link 15a and the second coupler link 15b, such that the second set of wheels is in the upper position, see FIG. 10, or the lower position, see FIG. 9, when the first wheel links 9 are in the first angular position and the second angular position, respectively.

The first coupler link 15a and the second coupler link 15b are configured to move in the second direction X towards the second wheel 8b and the fourth wheel 8d, respectively, when the first wheel links 9 are moved from the second angular position to the first angular position, and configured to move in the second direction X towards the first wheel 8a and the third wheel 8c, respectively, when the first wheel links 9 are moved from the first angular position to the second angular.

Each of the second wheel links 12 comprises a first edge section 37a extending upwards from the level of the third pivot coupling 13 and a second edge section 37b extending downwards from the level of the third pivot coupling 13. The first edge section 37a and the second edge section 37b face away from the connected first wheel link 9 and are inclined relative to each other such that the second wheel link 12 does not extend beyond an outer side of the first pair of wheels 7a, 7b when moved around the third pivot coupling 13.

The container handling vehicle 501 features four driven or motorized wheels, i.e. the first wheel 8a, the third wheel 8c and the second pair of wheels 7c, 7d. The remaining wheels of the exemplary embodiment are non-driven wheels.

The second wheel 8b and the fourth wheel 8d have a smaller diameter D1 than the diameter D2 of the first wheel 8a and the third wheel 8c, see FIG. 10. The smaller diameter allows the second wheel 8b and the fourth wheel 8d, i.e. the rotational axis of the second wheel 8b and the fourth wheel 8d, to be positioned further away from the second section without increasing the footprint of the container handling vehicle by extending beyond an outer side of the first pair of wheels 7a, 7b. The increased distance to the second section S2 ensures that the first wheel 8a and the third wheel 8c, i.e. two of the motorized wheels, support more weight and thus have an optimum traction. The larger diameter of the motorized wheels provides an optimum contact and traction with a rail system 108 upon which the container handling vehicle 501 may operate.

A drive shaft 24 interconnecting the first wheel links 9 is arranged in the second section S2. The drive shaft 24 is driven by a first electric motor 25 (i.e. a first wheel drive motor) and is operatively connected to drive the first wheel 8a and the third wheel 8c via respective drive bands 36.

A second electric motor 29 (i.e. a second wheel drive motor) for driving the second pair of wheels 7c, 7d is arranged in the second section S2. The second pair of wheels 7c, 7d is operatively connected to the second electric motor 29 by a drive band 35.

The drive shaft 24 and the cross-member 16 are configured to move in parallel when the first wheel links 9 are moved between the first and second angular position. The drive shaft 24 and the cross-member 16 are configured to move in unison with the first wheel links 9 between the first and second angular position. By moving the drive shaft in unison with the first wheel links 9, both excessive wear of the drive bands 36 due to stretching, and service involving tightening of the drive bands 36, are minimized.

In further embodiments, the remaining wheels, i.e. the second wheel 8b, the fourth wheel 8d and the first pair of wheels 7a, 7b, may be driven by wheel hub motors. However, the addition of further wheel drive motors is expensive and not considered to provide significant advantages related to speed and/or acceleration. Consequently, using a combination of driven and non-driven wheels can provide a cost-effective solution with minimal performance difference. Weight is also reduced through avoiding the additional driven wheels.

Substantially all drive, power and control components of the container handling vehicle 501 are arranged in the second section S2. The weight of these components is mainly supported by the driven wheels in or at the second section S2 such that the driven wheels will have excellent traction allowing high acceleration of the vehicle.

Power to drive the motors of the container handling vehicle is provided by a rechargeable battery 30 arranged in the second section S2. The rechargeable battery 30 is connected to a set of electrodes 31. The electrodes 31 are configured to receive power from a charging station. The two electrodes 31 are arranged on opposite sides of a vertical centre plane of the container handling vehicle, the vertical centre plane extending in the second direction X. An advantageous effect of having the electrodes 31 separated in this manner is that lateral skewing of the container handling vehicle relative to the second direction X during initial connection to a charging station is minimized. A suitable charging station is disclosed in e.g. PCT/EP2021/074340.

A control unit 19 for controlling at least the drive components (i.e. the first and second electric motor 25,29, the wheel lift motor 17 and the lift drive motor 28) is arranged in the second section (S2). By having all drive components and the battery arranged in the second section S2, cabling from the control unit 19 to any of the controllable components is minimized.

A set of replaceable distance pins 22 are arranged above the lifting frame 2. The distance pins 22 are configured to interact with switches 32 on an upper portion of the lifting frame 2 when the lifting frame 2 is in an upper position.

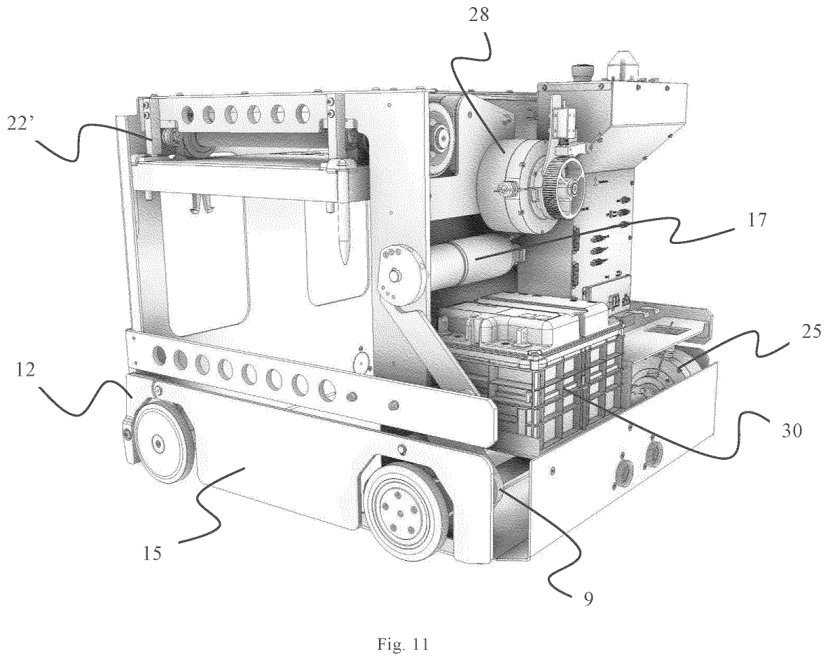

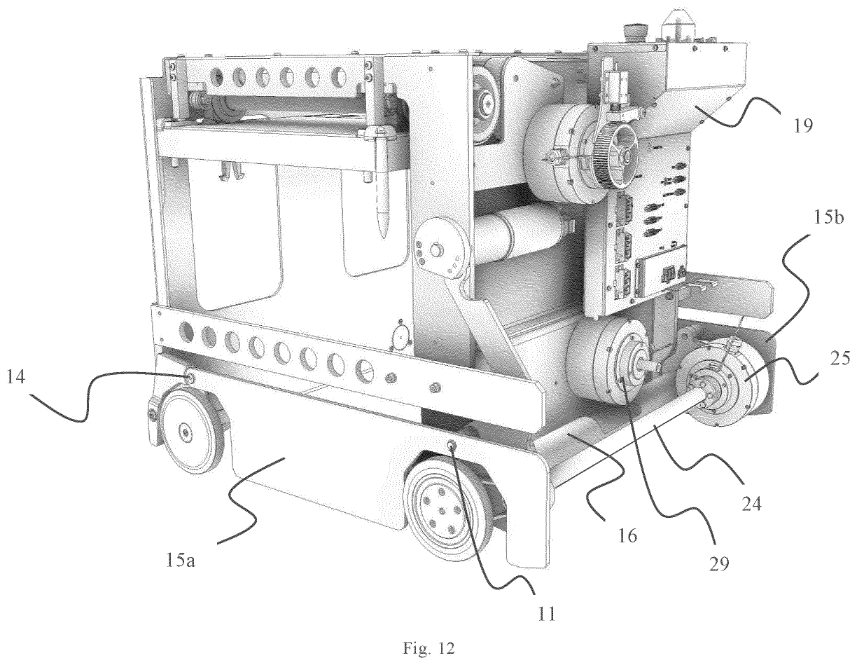

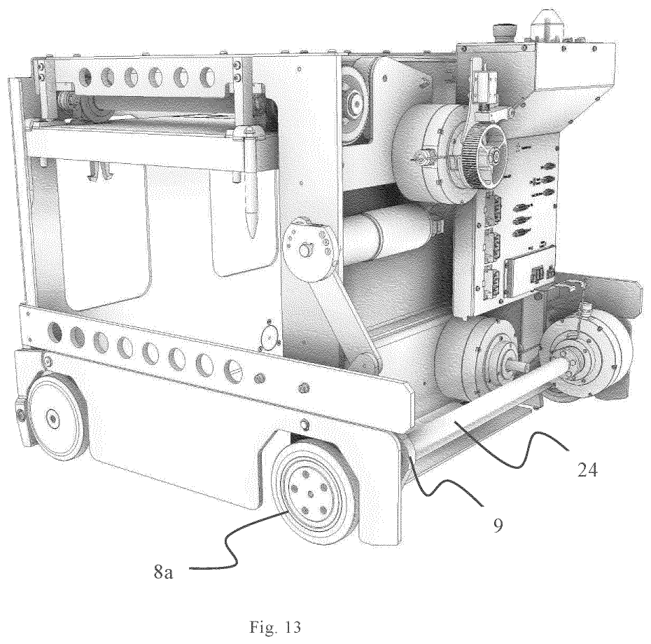

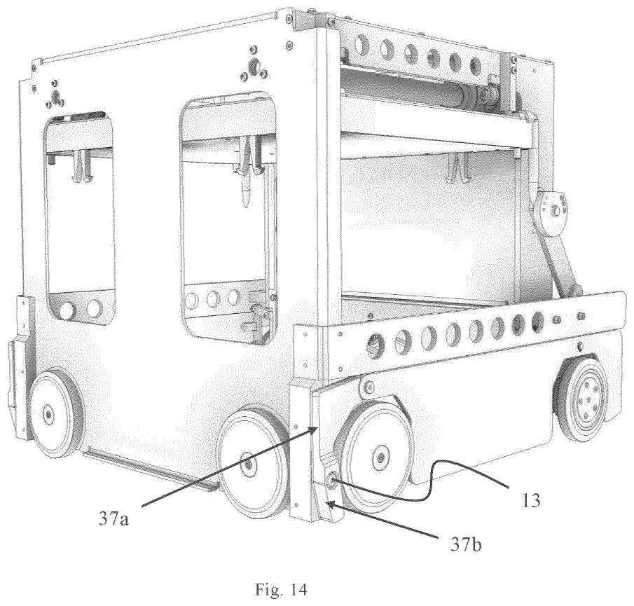

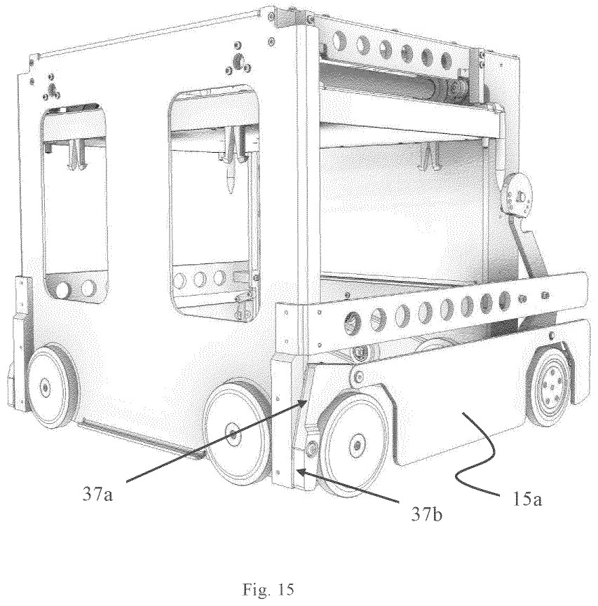

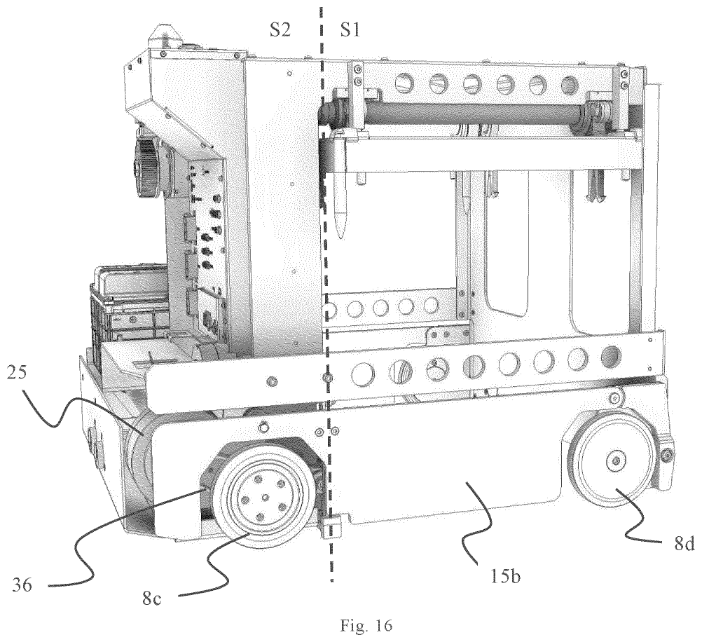

A second exemplary container handling vehicle 501′ is shown in FIGS. 11-16. The container handling vehicle 501′ is identical to the vehicle in FIGS. 6-10 except for the length of the distance pins 22′.

The distance pins 22,22′ ensure that the efficiency of the container handling vehicle 501,501′ may be optimized with respect to the height of the storage containers 106 being lifted. If the container handling vehicle 501 is to be used for higher storage containers, the shorter distance pins 22′ may be installed to ensure that the containers are not lifted higher than required for entering the cavity 26.

In alternative embodiments, the distance pins 22,22′ may be adjustable, i.e. have an adjustable height, instead of being replaceable. Adjustable distance pins may for instance be obtained by having telescopic or foldable distance pins.

Each of the container handling vehicles 501,501′ comprise four of the distance pins 22,22′ arranged to interact with the lifting frame at four corner sections. The distance pins 22,22′ may also be configured to stabilize the lifting frame 2, and any storage container 106 connected thereto, when the lifting frame 2 is in an upper position.

The configuration of the inventive container handling vehicle 501 allows for a highly efficient method of assembly since the second section S2 and a major part of the components making up the vehicle may constitute a preassembled vehicle module. The vehicle module may comprise the second section S2 of the vehicle frame 6 included the second pair of wheels 7c, 7d, the first wheel links 9, the first wheel 8a, the third wheel 8c, the first wheel drive motor 25, the second wheel drive motor 29, the lift drive motor 28, the actuator assembly 17,23, the drive shaft 24, the cross-member 16 and the control unit 19.

When a complete container handling vehicle is to be assembled, the first section S1 of the vehicle frame 6 may be connected to the vehicle module, the first section comprising the first pair of wheels 7a, 7b, the second wheel links 12, the second wheel 8b and the fourth wheel 8d, and finally interconnecting the first wheel links 9 to the respective second wheel links 12 by the first coupler link 15a and the second coupler link 15b.

### LIST OF REFERENCE NUMBERS

1 Prior art automated storage and retrieval system
2 Lifting frame
3 Container connector
4 Guiding pin
5 Lifting band
6 Vehicle frame
7a, 7b First pair of wheels
7c, 7d Second pair of wheels
8a,8b Third pair of wheels, first wheel, second wheel
8c,8d Fourth pair of wheels, third wheel, fourth wheel
9 First wheel link
10 First pivot coupling
11 Second pivot coupling
12 Second wheel link
13 Third pivot coupling
14 Fourth pivot coupling
15a First coupler link
15b Second coupler link
16 Cross-member
17 Wheel lift motor
18 Replaceable battery
19 Control unit
20 Wheel lift shaft
21a,21b Wheel lift plates
22 Distance pin
23 Actuator link
24 Drive shaft
25 First wheel drive motor
26 Cavity
27 Fifth pivot coupling
28 Lift drive motor
29 Second wheel drive motor
30 Rechargeable battery
31 Electrode
32 Switch/sensor
33 Lifting shaft
35 Drive band
36 Drive band
37a First edge section
37b Second edge section
38 Wheel hub motor
100 Framework structure
102 Upright members of framework structure
103 Horizontal members of framework structure
105 Storage column
106 Storage container
106′ Particular position of storage container
107 Stack
108 Rail system
110 Parallel rails in second direction (X)
110a First rail in second direction (X)
110b Second rail in second direction (X)
111 Parallel rail in first direction (Y)
111a First rail of first direction (Y)
111b Second rail of first direction (Y)
112 Access opening
119 First port column
120 Second port column
122 Grid cell
201 Prior art container handling vehicle
201a Vehicle body of the container handling vehicle 201
201b Drive means/wheel arrangement, second direction (X)
201c Drive means/wheel arrangement, first direction (Y)
301 Prior art cantilever container handling vehicle
301a Vehicle body of the container handling vehicle 301
301b Drive means in second direction (X)
301c Drive means in first direction (Y)
401 Prior art container handling vehicle
401a Vehicle body of the container handling vehicle 401
401b Drive means in second direction (X)
401c Drive means in first direction (Y)
D1,D2 Wheel diameter
S1 First section
S2 Second section
X Second direction
Y First direction
Z Third direction

1. A container handling vehicle for moving on a rail system, the rail system comprising a first set of parallel rails and a second set of parallel rails arranged perpendicular to the first set of parallel rails, the container handling vehicle comprising:
a vehicle frame defining a first section and a second section of the container handling vehicle, the first section and the second section being arranged side-by-side;
a first set of wheels comprising a first pair of wheels and a second pair of wheels, the first and second pairs of wheels arranged on opposite portions of the first section, the first set of wheels allowing movement of the container handling vehicle along a first direction (Y) on the rail system during use; and
a second set of wheels comprising a third pair of wheels and a fourth pair of wheels, the third and fourth pairs of wheels arranged on opposite sides of the container handling vehicle, each of the opposite sides extending from one edge of the first section to one edge of the second section, the second set of wheels allowing movement of the container handling vehicle along a second direction (X) on the rail system during use, the second direction (X) being perpendicular to the first direction (Y); the second set of wheels being arranged to be moveable in a vertical direction (Z) relative to the vehicle frame between an upper position in which the first set of wheels allows movement of the container handling vehicle along the first direction (Y), and a lower position in which the second set of wheels allows movement of the container handling vehicle along the second direction (X),
wherein:
the third pair of wheels comprises a first wheel and a second wheel and the fourth pair of wheels comprises a third wheel and a fourth wheel;
each of the first wheel and the third wheel is mounted to a corresponding first wheel link, each first wheel link comprises a first pivot coupling and a second pivot coupling and is pivotably connected to the vehicle frame by the first pivot coupling;
each of the second wheel and the fourth wheel is mounted to a corresponding second wheel link, each second wheel link comprises a third pivot coupling and a fourth pivot coupling and is pivotably connected to the vehicle frame by the third pivot coupling;
the first wheel link supporting the first wheel and the second wheel link supporting the second wheel are connected via the respective second and fourth pivot couplings by a first coupler link; and
the first wheel link supporting the third wheel and the second wheel link supporting the fourth wheel are connected via the respective second and fourth pivot couplings by a second coupler link.

2. The container handling vehicle according to claim 1, wherein the second section comprises:
an actuator assembly, the actuator assembly being arranged to move the first wheel links around the respective first pivot couplings between a first angular position and a second angular position, the movement of the first wheel links being transferred to the second wheel links via the first coupler link and the second coupler link, such that the second set of wheels is in the upper position or the lower position when the first wheel links are in the first angular position and the second angular position, respectively; and optionally wherein the second section comprises a cross-member fixing an angular position of the first wheel links relative to each other, such that the first wheel links move in unison around their respective first pivot coupling; and the actuator assembly is operatively connected to at least one of the first wheel links and is arranged to move the at least one of the first wheel links around the first pivot coupling between the first angular position and the second angular position.

3. (canceled)

4. The container handling vehicle according to claim 2, wherein the actuator assembly comprises one or more of:
a wheel lift motor or a linear actuator; or
an actuator link pivotably connected to one of the first wheel links.

5. The container handling vehicle according to claim 2, wherein at least one of the first wheel links comprises a fifth pivot coupling connected to the actuator assembly.

6. (canceled)

7. The container handling vehicle according to claim 1, further comprising:
a drive shaft interconnecting the first wheel links, the drive shaft operatively connected to drive the first wheel and the third wheel, preferably via respective drive bands; and optionally further comprising a first wheel drive motor for driving the drive shaft, the first wheel drive motor being arranged in the second section.

8. (canceled)

9. The container handling vehicle according to claim 7, further comprising:
a second wheel drive motor for driving the second pair of wheels, the second wheel drive motor being arranged in the second section, the second pair of wheels being preferably operatively connected to the second wheel drive motor by a drive band.

10. The container handling vehicle according to claim 2, wherein the first coupler link and the second coupler link are configured to move in the second direction (X) towards the second wheel and the fourth wheel, respectively, when the first wheel links are moved from the second angular position to the first angular position.

11. The container handling vehicle according to claim 1, wherein:
the first section comprises a lifting device for lifting a storage container and provides a cavity in which the storage container is accommodated,
the second wheel and the fourth wheel are positioned on opposite sides of the cavity, and optionally wherein the lifting device comprises a lifting frame and at least one rotatable lifting shaft configured to raise and lower the lifting frame via a set of lifting bands, the at least one rotatable lifting shaft being arranged in the first section above the cavity.

12. (canceled)

13. The container handling vehicle according to claim 11, comprising a lift drive motor for driving the lifting device, the lift drive motor being arranged in the second section.

14. The container handling vehicle according to claim 2, wherein:
the first coupler link and the second coupler link are configured to move in the second direction (X) towards the first wheel and the third wheel, respectively, when the first wheel links are moved from the first angular position to the second angular position,
or the first coupler link and the second coupler link are plate-shaped and provide covering which close off a lower portion of two sides of the container handling vehicle.

15. (canceled)

16. The container handling vehicle according to claim 1, wherein the first pivot coupling and the third pivot coupling are arranged at a level below the second pivot coupling and the fourth pivot coupling.

17. The container handling vehicle according to claim 1, further comprising:
a rechargeable battery arranged in the second section; and optionally further comprising a set of electrodes for receiving power from a charging station, the set of electrodes being arranged in the second section and connected to the rechargeable battery.

18. (canceled)

19. The container handling vehicle according to claim 1, further comprising a control unit arranged in the second section.

20. The container handling vehicle according to claim 1, wherein;
the first pair of wheels, the second wheel, and the fourth wheel are non-driven wheels, and optionally wherein the second wheel and the fourth wheel have a smaller diameter than a diameter of the first wheel and the third wheel.

21. The container handling vehicle according to claim 11, comprising a set of replaceable or adjustable distance pins, the distance pins being configured to interact with switches or sensors on the lifting frame when the lifting frame is in an upper position.

22. The container handling vehicle according to claim 1, wherein each of the second wheel links comprises a first edge section extending upwards from a level of the third pivot coupling and a second edge section extending downwards from the level of the third pivot coupling, the first edge section and the second edge section are directed away from the first wheel link and are inclined relative to each other and configured such that the second wheel link does not extend beyond an outer side of the first pair of wheels when moved around the third pivot coupling.

23. The container handling vehicle according to claim 1, wherein the first wheel and the third wheel are arranged in the second section.

24. (canceled)

25. A storage system comprising the container handling vehicle according to claim 1, the storage system comprising a framework structure having a plurality of storage columns for accommodating a vertical stack of storage containers, and a rail system upon which the container handling vehicle is configured to move in two perpendicular directions above the plurality of storage columns.

26. (canceled)

27. (canceled)

28. A method of changing the a direction of travel of the container handling vehicle according to claim 1, wherein the first wheel links are interconnected by a drive shaft and a cross-member, the drive shaft operatively connected to drive the first wheel and the third wheel, and the cross-member arranged to fix an angular position of the first wheel links relative to each other, such that the first wheel links move in unison around their respective first pivot coupling;
the method comprising the step of:
rotating the first wheel links, the drive shaft, and the cross-member in unison around an axis extending between the first pivot couplings, such that the first wheel links are moved from a first angular position to a second angular position, and the second set of wheels are moved from an upper position, wherein the container handling vehicle moves in the first direction (Y), to a lower position, wherein the container handling vehicle moves in the second direction (X).
